(19) United States
(12) Patent Application Publication
(10) Pub. No.: US 2010/0162096 A1
(43) Pub. Date: Jun. 24, 2010

(54) Techniques for Utilizing Dynamic Components with Wikis

(75) Inventors: Jason Morrill, Redmond, WA (US); Dwayne Jeng, Redmond, WA (US); Hai Liu, Sammamish, WA (US)

Correspondence Address: MICROSOFT CORPORATION, ONE MICROSOFT WAY, REDMOND, WA, 98052, US

(73) Assignee: Micorsoft Corpration, Redmond, WA (US)

(21) Appl. No.: 12/342,087

(22) Filed: Dec. 23, 2008

(51) Int. Cl. G06F 3/023

(52) U.S. Cl. 715/234

(57) ABSTRACT

Various technologies and techniques are disclosed for integrating wiki content with one or more dynamic components. A web page is output that contains wiki content that can be edited in a visual text editor. A selection is received from a user to add a dynamic component to the web page from within the visual text editor. A revised version of the web page is output for display. The revised version of the web page includes the dynamic component along with the wiki content. Techniques for parsing web pages having wiki content and dynamic components are also described that use a tag to indicate that the dynamic component is present.

### BACKGROUND

A wiki makes it easy for a document to be written collaboratively by multiple people using a Web browser and a simple markup language. Many wikis can be modified by the general public without requiring them to first open a user account. Some wikis do require that a user account be established before editing of a page is allowed.

A single page in a wiki is generally referred to as a “wiki page”, and the entire collection of pages is referred to as “the wiki”. Wiki pages are interconnected by hyperlinks. A simple markup language that is used to specify the structure and formatting of wiki pages is often referred to as “wikitext”. With wikitext, for example, a bulleted list is typically designated with an asterisk (“*”). The style and syntax of wikitexts can vary greatly among wiki implementations, but the feature that most or all of them have in common is the ease at which the plain text can be edited.

HTML, which is a markup language generally used for creating traditional web pages, uses a lot of cryptic tags. These cryptic tags are not very legible if you are just interested in reading and editing the content. Because of the complexity associated with HTML tags, wikis were designed to focus on plain text editing. This means that wikitexts have fewer and simpler conventions than HTML for indicating style and structure. Many wikis do support the insertion of rich text, images, and other static content. However, given the simplicity of wikis, additional add-on features are generally not supported in wikis beyond these basic text editing and formatting features.

### SUMMARY

Various technologies and techniques are disclosed for integrating wiki content with one or more dynamic components. A user selects an option to navigate to a web page using a web browser. A request is sent to a web server to obtain content for the web page. A response is received back from the web server with the page content for the web page, the page content including wiki content and at least one dynamic component. The web page is then output for display.

A method for adding dynamic components to web pages containing wiki content is described. A web page is output that contains wiki content that can be edited in a visual text editor. A selection is received from a user to add a dynamic component to the web page. A revised version of the web page is output for display. The revised version of the web page includes the dynamic component along with the wiki content.

Techniques for parsing web pages having wiki content and dynamic components are also described that use a tag to indicate that the dynamic component is present. A request is received from a client browser for a web page containing wiki content. The web page is parsed to create a rendering output for the client browser. When a tag for a dynamic component is encountered during the parsing step, the identifying details of the tag are retrieved, the identifying details are used to retrieve underlying content for the dynamic component from a data store, and the rendering output is updated to include at least a portion of the underlying content of the dynamic component. The rendering output of the web page is returned to the client browser.

This Summary was provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

### BRIEF DESCRIPTION OF THE DRAWINGS

FIG. 1 is a diagrammatic view of a system for integrating dynamic components with wiki content.

FIG. 2 is a process flow diagram for one implementation illustrating the stages involved in displaying a web page with wiki content and one or more dynamic components.

FIG. 3 is a process flow diagram for one implementation illustrating the stages involved in parsing a web page that contains wiki content and a special tag for dynamic components.

FIG. 4 is a diagrammatic view for one implementation illustrating a logical view of a web page using special tags for indicating dynamic components as seen by a web server.

FIG. 5 is a diagrammatic view for one implementation illustrating a logical view of the exemplary web page shown in FIG. 4 when rendered in a client browser.

FIG. 6 is a process flow diagram for one implementation illustrating the stages involved in adding a dynamic component to a web page containing wiki content.

FIG. 7 is a process flow diagram for one implementation that illustrates the stages involved in enabling a user to modify the dynamic component(s) once they are added to the page with the wiki content.

FIG. 8 is a simulated screen for one implementation that illustrates a web page that enables editing of wiki content using a visual text editor, while also displaying a dynamic component.

FIG. 9 is a simulated screen for one implementation that illustrates the insertion of a new dynamic component into an existing web page with wiki content.

FIG. 10 is a simulated screen for one implementation that illustrates an options dialog box for specifying the name and type of list being inserted as a dynamic component.

FIG. 11 is a simulated screen for one implementation that illustrates an options dialog box for specifying additional details regarding the list being inserted as a dynamic component.

FIG. 12 is a simulated screen for one implementation that illustrates the insertion of the new list illustrated in FIGS. 10-11 as a dynamic component on the web page, and the ability to select dynamic components for deletion.

FIG. 13 is a diagrammatic view of a computer system of one implementation.

### DETAILED DESCRIPTION

The technologies and techniques herein may be described in the general context as an application that integrates wiki content with dynamic components, but the technologies and techniques also serve other purposes in addition to these. In one implementation, one or more of the techniques described herein can be implemented as features within a wiki, within a content management program such as MICROSOFT® SharePoint, or from any other type of program or service that allows end users to edit data in a visual text editor in a web browser.

In one implementation, techniques are described herein for providing a web page that allows a user to edit wiki content in a visual text editor, but that also allow for dynamic components to be displayed and edited within the same visual text editor. The term “dynamic component” as used herein is meant to include a component that gets displayed on a web page that is extensible and can use server and/or client code to render itself and interact with the user. One non-limiting example of a dynamic component can include a component that contains data that lives external to the web page and that can be viewed and/or edited separately by one or more other applications. Another non-limiting example of a dynamic component can include a component that updates over time to display a current phase of the moon. Yet another non-limiting example of a dynamic component can include a game that the user can play. The term “wiki content” as used herein is meant to include content that can be edited in a quick and visual fashion within a web browser.

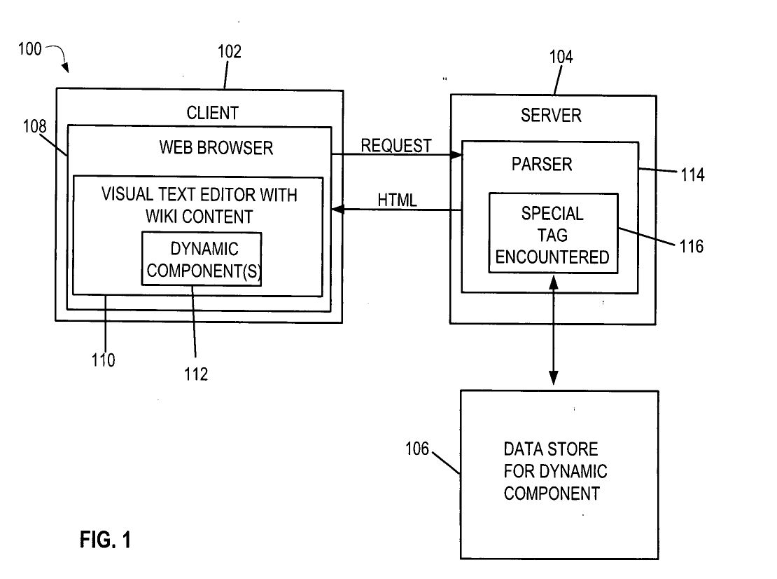

FIG. 1 is a diagrammatic view of a system 100 for integrating dynamic components with wiki content. In the example shown, system 100 includes a client computer 104, a server computer 104, and a data store for one or more dynamic components 106. It will be appreciated that in other implementations, additional or fewer computers and/or data stores can be used. These are just shown for the sake of illustration.

Client computer 104 includes a web browser 108 that communicates with a web server 104 to retrieve web pages upon request. The server computer 104 contains a parser 114 that retrieves the web page upon request from the client computer 104 and then parses the web page to convert the web page into a rendering output (such as HTML) that the client web browser 108 can understand and display. The parser searches for any special tags 116 that indicate dynamic components are present. If any special tags 116 are found, then the underlying content for the one or more dynamic components are retrieved from one or more data stores 106, such as from third party servers, or from server 104.

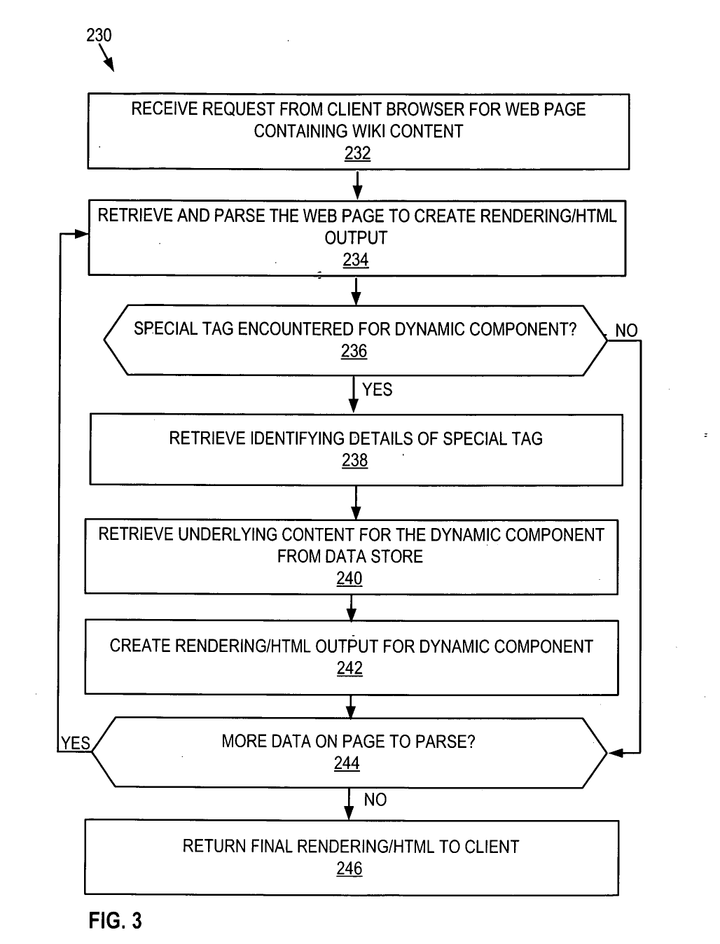

The parsing process that is performed by the server computer 104 is described in more detail in FIGS. 3-5. While the examples discussed herein illustrate the use of one server computer for performing the parsing, it will be appreciated by one in the computer software art that there could be multiple servers assisting with the parsing or other processes performed by server computer 104, such as in load balancing scenarios where multiple servers are used to do a share of the work.

The web browser 108 of client computer 102 contains a visual text editor 110 with wiki content. The visual text editor 110 with wiki content has the ability to display one or more dynamic component(s) 112. At the point the web page is first loaded on the client 102, there may or may not be any dynamic component(s) 112 displayed yet. Dynamic component(s) 112 can be added by end users, administrators, and/or programmatically so that they appear inside the visual text editor 110 that has the wiki content.

Users can then edit and/or apply further formatting to the content inside the dynamic component(s) 112 using one or more of the editing and formatting features supported by the visual text editor. The user can interact with the dynamic component(s) 112 as part of the wiki content. As one non-limiting example, the dynamic component(s) 112 can be centered, left aligned, and/or right aligned in comparison to wiki content. As another non-limiting example, the dynamic component(s) can be dragged around inside the visual text editor 110. As yet another non-limiting example, additional contents can be added to the dynamic component(s) 112 from directly within the visual text editor 110 and/or by selecting an option within the visual text editor 110 that will bring up another dialogue box for allowing the user to add the data.

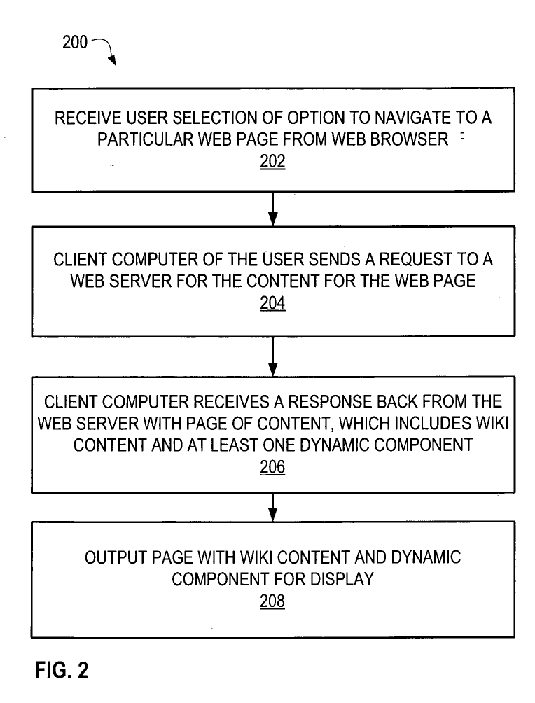

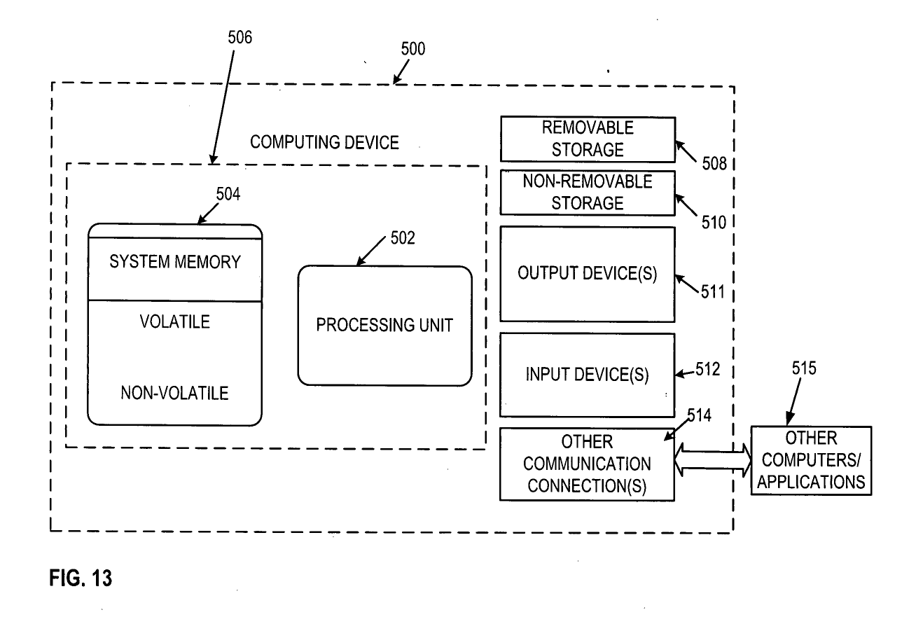

Turning now to FIGS. 2-12, the stages for implementing one or more implementations of system 100 are described in further detail. In some implementations, the processes of FIG. 2-12 are at least partially implemented in the operating logic of computing device 500 (of FIG. 13).

FIG. 2 is a process flow diagram 200 that illustrates one implementation of the stages involved in displaying a web page with wiki content along with one or more dynamic components. A user selection is received of an option to navigate to a particular web page from a web browser (stage 202). As a few non-limiting examples, the user selection can be received by the user entering a particular web address into the address bar, by the user selecting a bookmark that already has the web address saved, or by the user clicking on a hyperlink contained on another web site that points to the particular web page.

The client computer sends a request to a web server for the content for the web page (stage 204). The client computer receives a response back from the web server with the page of content (stage 206). This page of content includes wiki content and at least one dynamic component (stage 206). This dynamic component could have been added to the web page by the current user during an earlier visit to this web page, as one example. Or, this dynamic component could have been added by other users. The page with the wiki content and the dynamic component(s) are then output for display (stage 208).

FIG. 3 is a process flow diagram 230 that illustrates one implementation of the stages involved in parsing a web page that contains wiki content and a special tag for dynamic components. A request is received from a client web browser for a web page containing wiki content (stage 232). For example, this request can be received from the client browser because an end user has selected an option to access the web page with the wiki content. The web page is retrieved when applicable, and then parsed to create a rendering output that the client browser will understand (stage 234). In one implementation, the rendering output that is used is an HTML format.

During the parsing of the page, if a special tag is encountered in the wiki content that represents a dynamic component (decision point 236), then the identifying details of the special tag are retrieved (stage 238). The identifying details of the special tag give information that is useful for retrieving the underlying content for the dynamic component. Thus, the underlying content for the dynamic component is then retrieved from a data store (stage 240). The rendering output is updated to include at least some of the underlying content for the dynamic component (stage 242). In some cases, there may have been more data retrieved from the data store than can be displayed in the dynamic component on the screen. Thus, some or all of the underlying data may be included in the rendering output for display back on the client browser. When there is more data on the page to parse (decision point 244), then the parsing process continues so that the rest of the web page (along with any other special tags) can be converted into the rendering output (stage 234).

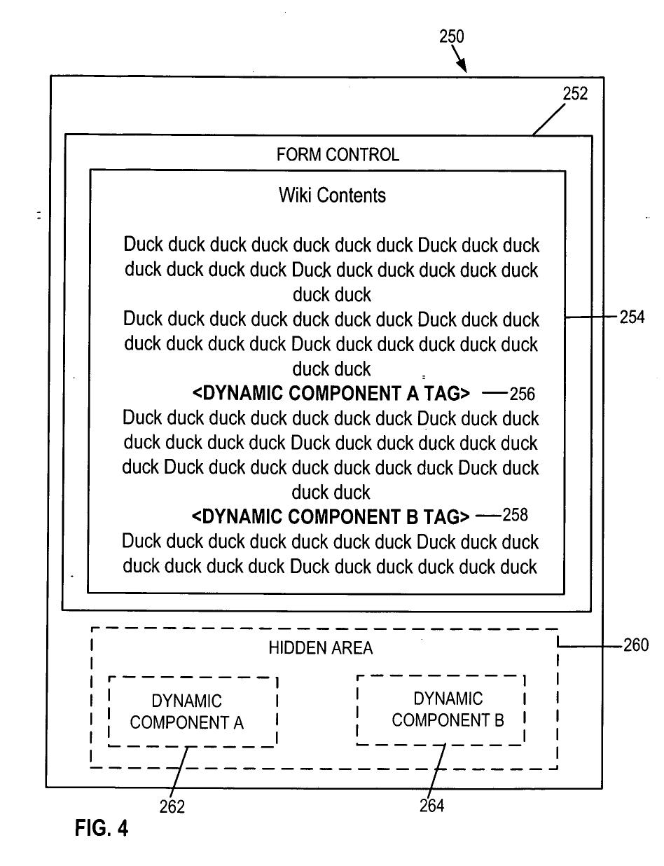

Once the parsing process is finished to generate the final rendering output for the client browser, then the final rendering output is returned back to the client browser so it can be displayed to the user (stage 246). Additional details regarding the special tag that can be encountered during the parsing process are provided in the discussion of FIG. 4, which will now be discussed.

FIG. 4 is a diagrammatic view 250 of one implementation that illustrates a logical view of a web page using special tags for indicating dynamic components as seen by a web server. In the example shown, special tags (256 and 258) are contained in the wiki contents 254 to indicate that a dynamic component that is defined elsewhere should be rendered at the location of the special tag. For example, the first tag 256 lets the parser know that dynamic component A should be retrieved, and that the dynamic component should be displayed in the location of the first tag 256 once the underlying contents of the dynamic component are retrieved. Similarly, the second tag 258 lets the parser know that dynamic component B should be retrieved and displayed in the location of the second tag 258. There could be any number of tags included in a web page, and two are just shown in FIG. 4 for the sake of illustration.

Furthermore, the exact syntax of the special tag can be in one of a variety of formats. As one non-limiting example, the special tag can indicate an identifier or bookmark of a location on the web page or an external data source where more details about the dynamic component can be found. In the example shown in FIG. 4, the special tags (254 and 256) contain identifiers that point to a hidden area 260. This hidden area is not visible to end users when the page is displayed, but contains additional details about the dynamic components on the page. For example, the first special tag 256 corresponds to the first region 262 in the hidden area 260. The second special tag 258 corresponds to the second region 264 in the hidden area 260. Each of these regions in the hidden area 260 then contain additional details about their respective dynamic component, such as the location of the underlying data that can be retrieved for the respective dynamic component.

As another non-limiting example, the special tag can include the name of an API that should be consulted to retrieve the underlying dynamic component. Other variations are also possible for indicating that a dynamic component whose data is contained elsewhere should be inserted at the location where the tag is contained, or at another specified location.

In the example shown in FIG. 4, the wiki contents 254 are stored in a form control 252. In some object oriented programming environments, form controls are often used to allow development of user interface forms with different regions and controls placed in those regions. In one implementation, these wiki contents 254 are stored in a wiki field on a list item. In other implementations, a form control is not used at all. In yet other implementations, the wiki contents are stored somewhere other than in a wiki field on a list item.

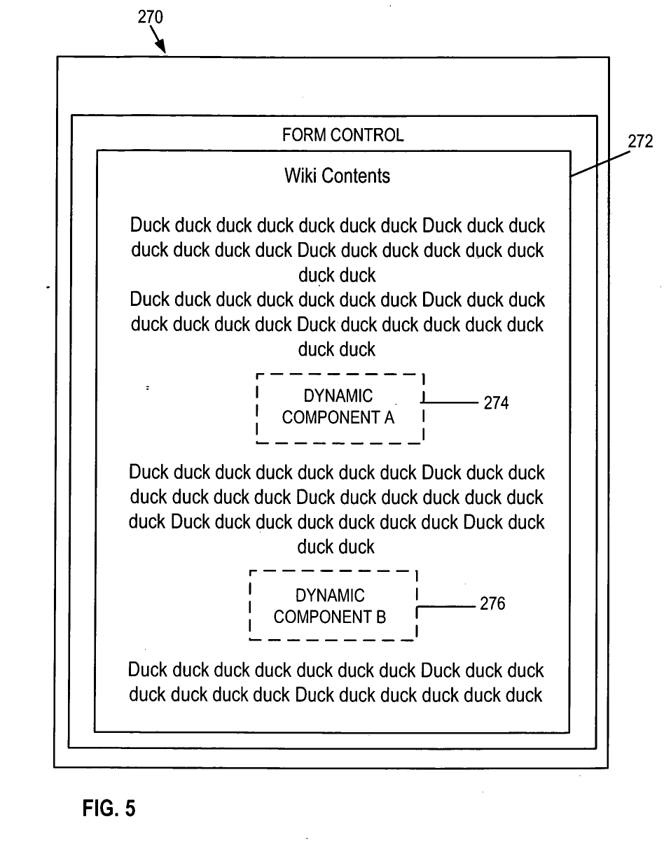

Turning now to FIG. 5, a diagrammatic view 270 of one implementation is shown that illustrates a logical view of the exemplary web page from FIG. 4 when rendered in a client browser. In this example, when the web page gets transmitted in the rendering output format (such as HTML) on the client browser, the dynamic components (274 and 276) have been inserted into the respective location that was indicated by the special tags (256 and 258, respectively) in FIG. 4.

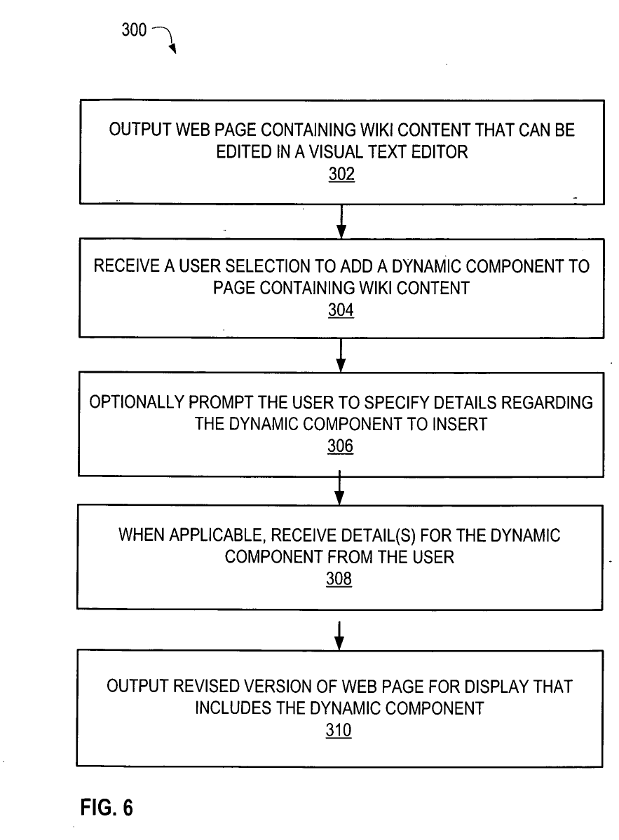

FIG. 6 is a process flow diagram 300 that illustrates one implementation of the stages involved in adding a dynamic component to a web page containing wiki content. A web page that contains wiki content that can be edited in a visual text editor is output for display (stage 302), such as after the web page is received from a web server. A user selection is received to add a dynamic component to the page that contains the wiki content (stage 304).

The user is then optionally prompted to specify one or more details regarding the dynamic component to insert (stage 306). A few non-limiting examples of details that the user may be prompted to specify include a name for the dynamic component, a type of component (such as a list, etc.), a specific type of list, and so on. When applicable, the one or more details for the dynamic component are received from the user (stage 308). Code behind the visual text editor is updated to contain a tag to indicate that information regarding the dynamic component can be retrieved from a separate region of the web page. A revised version of the web page is then output for display (stage 310). This revised version of the web page contains the newly added dynamic component, along with the wiki content from before. The underlying content for the dynamic component that is displayed in the revised version of the web page can be retrieved by the web server, such as from a third party server that is external to the web server.

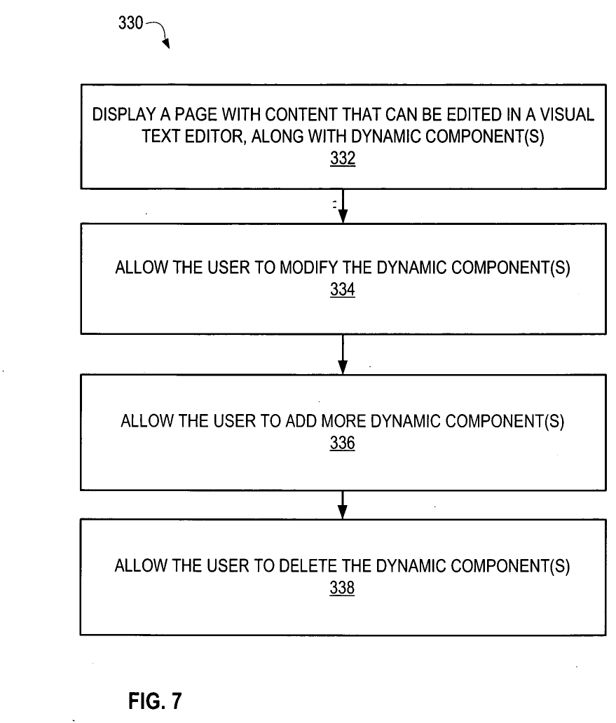

FIG. 7 is a process flow diagram 330 that illustrates one implementation of the stages involved in enabling a user to modify the dynamic component(s) once they are added to the page with the wiki content. Note that while FIG. 7 is described as a series of stages, no particular order is intended. The stages described in FIG. 7 could be performed in any order, with some steps possibly even being omitted. A page is displayed that contains content that can be edited in a visual text editor, as well as one or more dynamic components (stage 332). Functionality is provided in the web page to allow the user to modify the dynamic component(s) (stage 334), add more dynamic component(s) (stage 336), and/or delete the dynamic component(s) (stage 338).

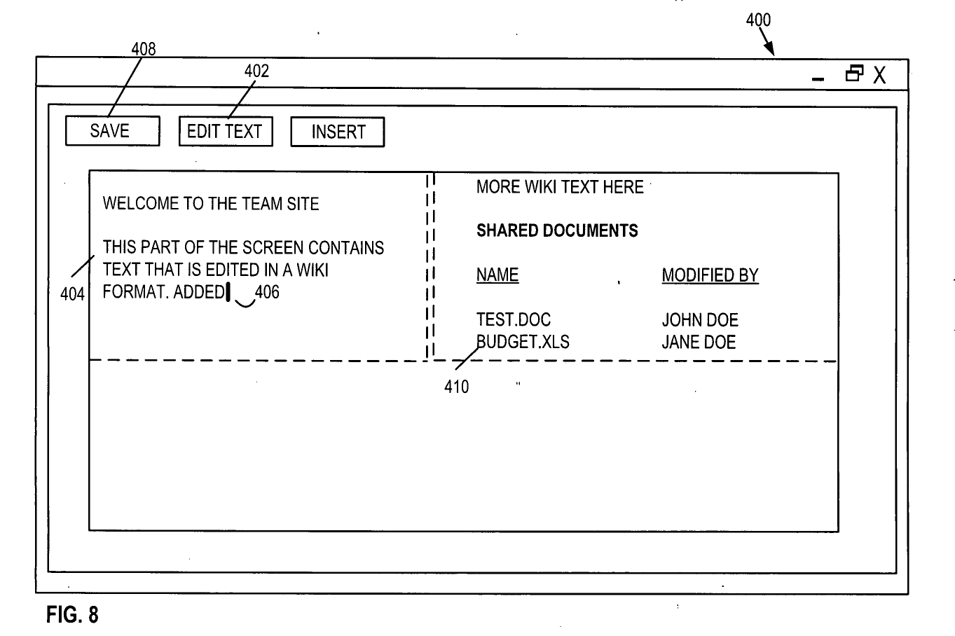

Turning now to FIGS. 8-12, simulated screens are shown to illustrate some exemplary user interfaces of system 100 where wiki content is integrated with one or more dynamic components. These screens can be displayed to users on output device(s) 511 (of FIG. 13). Furthermore, these screens can receive input from users from input device(s) 512 (of FIG. 13).

FIG. 8 is a simulated screen 400 for one implementation that illustrates a web page that enables editing of wiki content using a visual text editor, while also displaying a dynamic component. Upon selecting an option to edit the text, such as edit text option 402, the user is able to edit the wiki content 406 in a visual text editor 404. The changes that are made to the wiki content 406 can be saved, such as upon selecting a save option 408. A dynamic component 410 is also displayed that contains a list of shared documents. In one implementation, some portions of the dynamic component can also be edited using the visual text editor, such as to apply alignment or other formatting details.

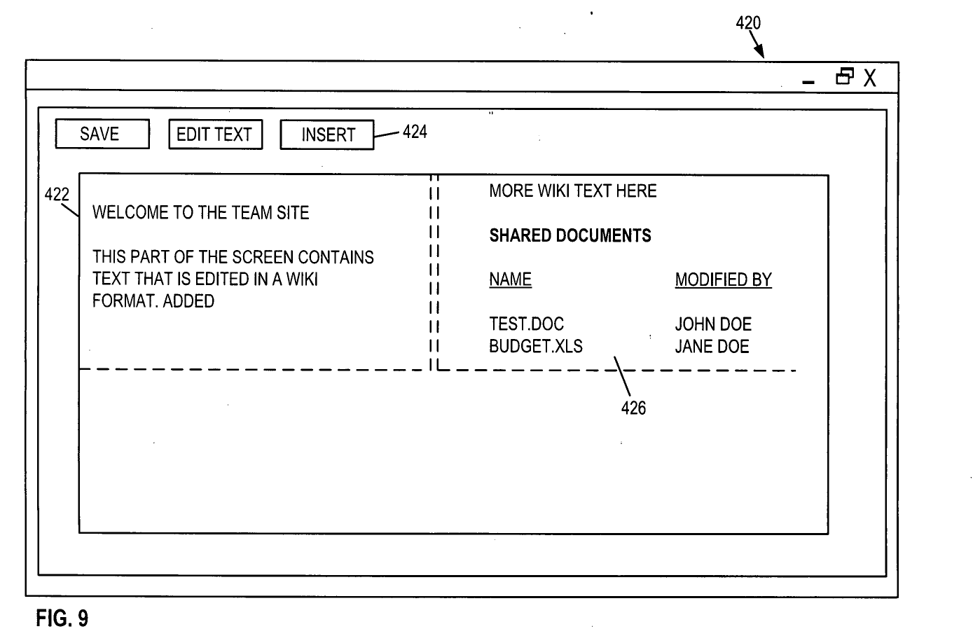

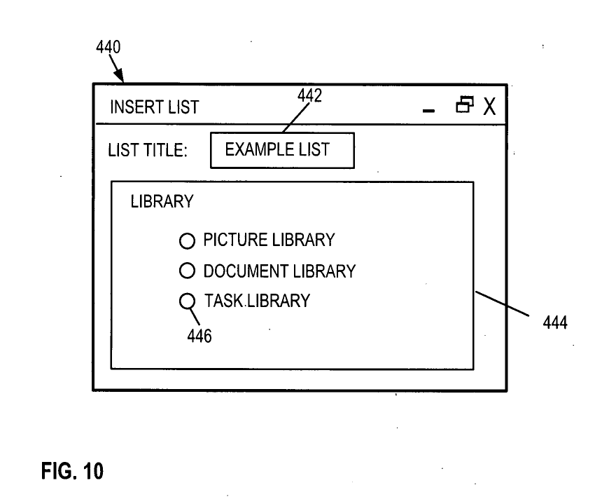

FIG. 9 is a simulated screen 420 for one implementation that illustrates the insertion of a new dynamic component into an existing web page with wiki content. In this example, there is already wiki content 422 along with a dynamic component 426 already being displayed on the screen in a visual text editor. In this example, the dynamic component 426 is a document list that shows some documents that are being shared by multiple members of a team. Suppose that the user wants to insert another dynamic component into the page. The user can select an insert option 424. A dialog box similar to FIG. 10 can then be displayed.

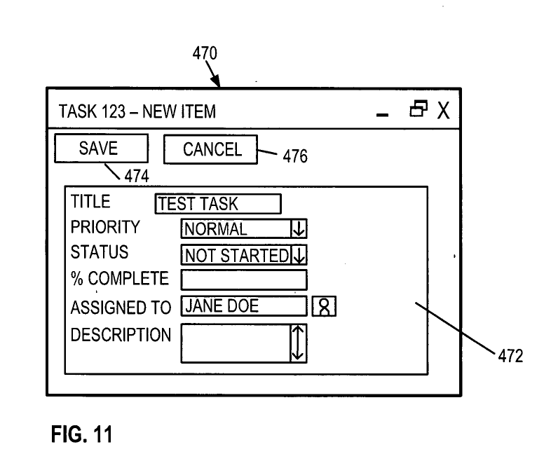

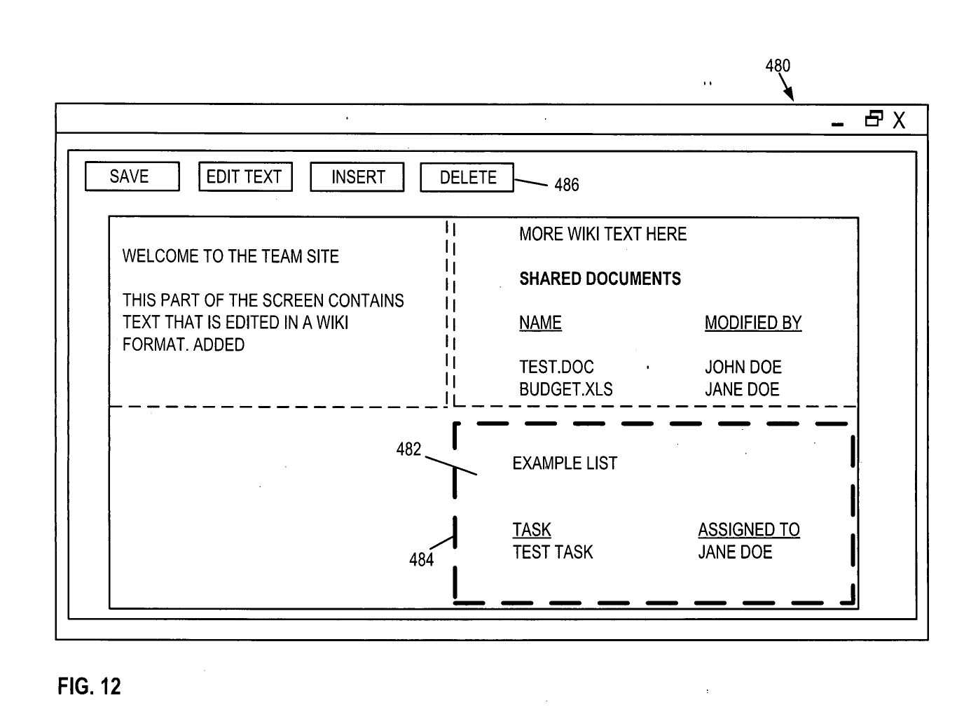

FIG. 10 is a simulated screen 440 for one implementation that illustrates an options dialog box for specifying the name and type of list being inserted as a dynamic component. In this example, the user is prompted to specify a title 442 for the dynamic component, as well as the type of dynamic component 444. In this example, the type of component being inserted is a list, so the user is prompted to specify the type of list that is to be inserted. For purposes of this example, the task library option is being selected 446. This will be further illustrated on FIGS. 11 and 12, which are discussed next.

FIG. 11 is a simulated screen 470 for one implementation that illustrates an options dialog box for specifying additional details regarding the list being inserted as a dynamic component. In some implementations, this may be a dialog box that prompts the user to add entries into a list. In such a scenario, the dialog box can be displayed automatically upon creation of a new dynamic component without the user needing to select another option to add items to the dynamic component. In other implementations, the user can separately select an option to add specific content items to the dynamic component.

In this example, the additional details 472 being specified for the dynamic component includes information about an actual task to be inserted into the task list that was just created as a dynamic component. Examples of such task details include a task title, priority, status, percent complete, assigned to name, and description. In the example shown, the user can then either select the option to save 474 the new task item or to cancel 476 the addition of the new task item.

FIG. 12 is a simulated screen 480 for one implementation that illustrates the insertion of the new list illustrated in FIGS. 10 and 11 as a dynamic component on the web page, as well as the ability to select dynamic components for deletion. In this example, the dynamic component 482 containing a task list that was just described in FIGS. 10 and 11 is now displayed on the web page, along with the wiki content and the other dynamic component that previously existed. In one implementation, the user can select any of the dynamic components and then select an option to delete the dynamic component. The newly inserted task list is shown in this example as having an outline 484 that indicates it has been selected by the user. Upon selecting delete option 486, this dynamic component 482 can be removed from the web page.

As shown in FIG. 13, an exemplary computer system to use for implementing one or more parts of the system includes a computing device, such as computing device 500. In its most basic configuration, computing device 500 typically includes at least one processing unit 502 and memory 504. Depending on the exact configuration and type of computing device, memory 504 may be volatile (such as RAM), non-volatile (such as ROM, flash memory, etc.) or some combination of the two. This most basic configuration is illustrated in FIG. 13 by dashed line 506.

Additionally, device 500 may also have additional features/functionality. For example, device 500 may also include additional storage (removable and/or non-removable) including, but not limited to, magnetic or optical disks or tape. Such additional storage is illustrated in FIG. 13 by removable storage 508 and non-removable storage 510. Computer storage media includes volatile and nonvolatile, removable and non-removable media implemented in any method or technology for storage of information such as computer readable instructions, data structures, program modules or other data. Memory 504, removable storage 508 and non-removable storage 510 are all examples of computer storage media. Computer storage media includes, but is not limited to, RAM, ROM, EEPROM, flash memory or other memory technology, CD-ROM, digital versatile disks (DVD) or other optical storage, magnetic cassettes, magnetic tape, magnetic disk storage or other magnetic storage devices, or any other medium which can be used to store the desired information and which can accessed by device 500. Any such computer storage media may be part of device 500.

Computing device 500 includes one or more communication connections 514 that allow computing device 500 to communicate with other computers/applications 515. Device 500 may also have input device(s) 512 such as keyboard, mouse, pen, voice input device, touch input device, etc. Output device(s) 511 such as a display, speakers, printer, etc. may also be included. These devices are well known in the art and need not be discussed at length here.

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims. All equivalents, changes, and modifications that come within the spirit of the implementations as described herein and/or by the following claims are desired to be protected.

For example, a person of ordinary skill in the computer software art will recognize that the examples discussed herein could be organized differently on one or more computers to include fewer or additional options or features than as portrayed in the examples.

What is claimed is:

1. A method for integrating wiki content with dynamic components comprising the steps of:
receiving from a user a selection of an option to navigate to a web page using a web browser;
sending a request to a web server to obtain content for the web page;
receiving a response back from the web server with the page content for the web page, the page content including wiki content and at least one dynamic component; and
outputting the web page for display.

2. The method of claim 1, further comprising the steps of:
enabling the user to edit the wiki content and the at least one dynamic component using a visual text editor that is displayed on the web page.

3. The method of claim 1, wherein the dynamic component was added to the web page by the user on an earlier visit to the web page.

4. The method of claim 1, wherein the response is received back from the web server in an HTML format.

5. The method of claim 1, wherein the at least one dynamic component includes a task list.

6. The method of claim 1, wherein the at least one dynamic component includes a document list.

7. A method for adding dynamic components to web pages containing wiki content comprising the steps of:
outputting a web page containing wiki content that can be edited in a visual text editor;
receiving a selection from a user to add a dynamic component to the web page; and
outputting a revised version of the web page for display, the revised version of the web page including the dynamic component along with the wiki content.

8. The method of claim 7, further comprising the steps of:
in response to the selection from the user, prompting the user to specify at least one detail regarding the dynamic component; and
prior to outputting a revised version of the web page, receiving the at least one detail regarding the dynamic component from the user.

9. The method of claim 7, further comprising the steps of:
allowing the user to edit the wiki content and the dynamic component from within the visual text editor.

10. The method of claim 9, wherein the user can specify an alignment of the dynamic component from within the visual text editor.

11. The method of claim 9, wherein the user can specify formatting options of the dynamic component from within the visual text editor.

12. The method of claim 7, wherein the user can edit contents of the dynamic component from within the visual text editor.

13. The method of claim 7, wherein upon receiving the at least one detail regarding the dynamic component from the user, code behind the visual text editor is updated to indicate that information regarding the dynamic component can be retrieved from a separate region of the web page.

14. The method of claim 13, wherein the separate region of the web page is a hidden area of the web page.

15. The method of claim 7, wherein the web page is retrieved from a web server prior to the outputting the web page step, and wherein prior to the outputting the revised web page step, the web server retrieves contents of the dynamic component from a third party server that is external to the web server.

16. A computer-readable medium having computer-executable instructions for causing a computer to perform steps comprising:
receiving a request from a client browser for a web page containing wiki content;
parsing the web page to create a rendering output for the client browser;
when a tag for a dynamic component is encountered in the wiki content during the parsing step, performing the steps of:
retrieving identifying details of the tag;
using the identifying details to retrieve underlying content for the dynamic component from a data store; and
updating the rendering output to include at least a portion of the underlying content of the dynamic component; and
returning the rendering output of the web page to the client browser.

17. The computer-readable medium of claim 16, wherein the rendering output of the web page is created in an HTML format.

18. The computer-readable medium of claim 16, wherein the underlying content for the dynamic component is retrieved from a third party server.

19. The computer-readable medium of claim 16, wherein the identifying details of the tag are included in a hidden area of the web page.

20. The computer-readable medium of claim 16, wherein the web page is stored on the web server in a form control.
